(19) United States
(12) Patent Application Publication
(10) Pub. No.: US 2009/0057373 A1
(43) Pub. Date: Mar. 5, 2009

(54) Multi-Purpose End Effector for Welder

(75) Inventors: Ayad K. Darzi, Grand Blanc, MI (US); Robert L. Keyes, Troy, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/847,684

(22) Filed: Aug. 30, 2007

(51) Int. Cl. B23K 28/00; B23K 26/00; B23K 37/00

(52) U.S. Cl. 228/18; 219/74

(57) ABSTRACT

A multi-purpose end effector for a welding robot includes a base plate mounted on a robot and carrying a plurality of tools including a welder, a cleaning wheel for cleaning a workpiece, and a buffing wheel for buffing the weld. The tools are arranged in serial order on the base plate beginning with the cleaning wheel to clean workpieces, then the welder for welding the workpieces, and then the buffing wheel to buff the weld.

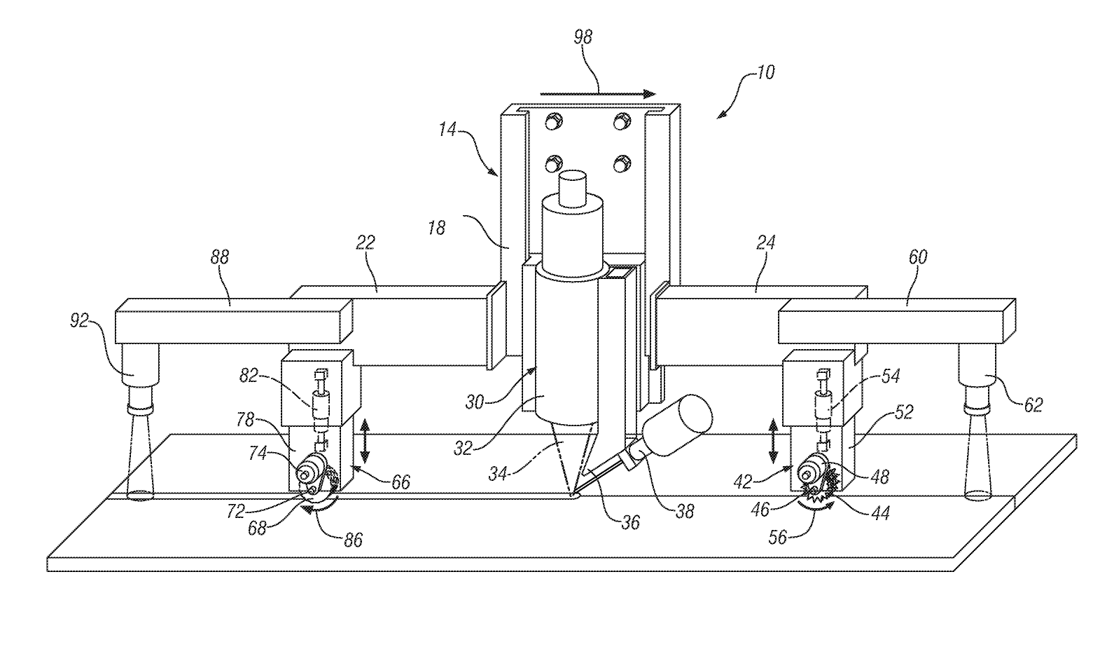

### FIELD OF THE INVENTION

The present invention relates to a multi-purpose end effector for a robotic welder and, more particularly, an end effector for mounting a plurality of tools for improved manufacturing efficiency.

### BACKGROUND OF THE INVENTION

It is well known in manufacturing, particularly the manufacture of vehicle bodies, to utilize welding to attach together workpieces such as the sheet metal panels that form a vehicle roof, a vehicle door, a vehicle hood panel, or other parts of the vehicle body.

The workpieces must be cleaned prior to the welding operation, and also the welded joint must be buffed after the welding operation. Accordingly, in conventional vehicle body manufacture, the vehicle body travels to a first station where a multi-access manipulator, such as a robot wields a cleaning wheel to clean the work pieces. Thereafter, the vehicle body travels to an adjacent work station where another robot wields a welder to weld together the adjoining work pieces. After welding, the vehicle body then travels to another work station where another robot wields a buffing wheel to buff the welded joint, thereby removing weld flash and preparing the work piece for subsequent painting or other finishing processes.

The aforedescribed manufacturing process thus requires multiple robots and also requires substantial floor space in the manufacturing plant so that the vehicle body can travel on a conveyor through the cleaning station, the welding station, and the buffing station.

It would be desirable to improve the efficiency of vehicle manufacture by reducing the number of robots and also reducing the amount of floor space required to move the vehicle body through a series of work stations.

### SUMMARY OF THE INVENTION

A multi-purpose end effector is provided for a multi-access manipulator, such as a robot, and includes a base plate mounted on the robot and a welder carried by the base plate for welding a joint between the adjoining surfaces of two adjacent work pieces as the multi-access manipulator moves the welder along the joint. A cleaning wheel is carried by the base plate on one side of the welder so that the cleaning wheel precedes the welder as the multi-access manipulator moves the welder along the joint so as to clean the adjoining surfaces in preparation for the welder. A buffing wheel is carried by the base plate on the other side of the welder from the cleaning wheel so that the buffing wheel follows behind the welder as the robot moves the welder along the joint so as to buff the welded joint after welding. A vision camera mounted on the base plate precedes the cleaning wheel to guide the multi-access manipulator and an inspection camera follows behind the buffing wheel to gather quality data.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

The drawing is a perspective view of a multi-purpose end effector according to the invention.

### DETAILED DESCRIPTION OF THE EXEMPLARY EMBODIMENTS

The following description of certain exemplary embodiments is exemplary in nature and is not intended to limit the invention, its application, or uses.

The terms “welding” and “welder” as used herein refers in the generic sense to processes and equipment for joining separate pieces of metal in a continuous metallic bond, including for example arc welding and laser welding, in which the workpieces become partly melted, and brazing and soldering where nonferrous filler metals are used without melting the parts that are being joined.

The term robot as used herein refers to a programmable machine for performing complicated tasks, and can be any device that can manipulate a tool about many axis of movement.

Referring to the drawing, an end effector assembly, generally indicated at 10, includes a base plate assembly 14 that is mounted on a robot, not shown in the drawing but well known, and commercially available. The base plate 14 includes a central base portion 18 having mounting arms 22 and 24 that extend outwardly in opposite directions from the central base plate 18. The base plate will carry a plurality of tools, as described herein.

As seen in the drawing, a welder generally indicated at 30 is mounted on the base plate 14 and in particular includes a laser welder 32 that emits a weld beam 34. The laser welder 32 has a pipe 36 for shielding gas and a dispenser 38 for welding wire. A cleaning wheel mechanism, generally indicated at 42, is mounted on the arm 24 and includes a cleaning wheel 44 that is rotated about a shaft 46 by a motor 48. The cleaning wheel 44 may be, for example, a wire brush or abrasive disc, or other material for abrading the workpieces that are to be welded. The cleaning wheel 46 is mounted on a housing 52 that can be selectively raised and lowered relative the arm 24 by a height adjusting mechanism 54. The height adjusting mechanism 54 can be a hydraulic cylinder, a jack screw, or other known adjusting type device. The adjusting mechanism 54 will enable the cleaning wheel 44 to move up and down relative the mounting arm 24 as needed to adjust for wear of the cleaning wheel 44 or to accommodate or to better fit the cleaning wheel 44 to the shape of the workpieces. The cleaning wheel may rotate in the direction of arrow 56 so that any offal is pushed away from the laser welder 32.

The arm portion 24 of the base plate 14 also includes an arm portion 60 that mounts a vision or guidance device 62, such as a camera. The vision device 62 observes the workpiece and provides data to the robot so that the position of the end effector 10 can be modified as needed to precisely guide the end effector 10 along the workpieces as desired.

The arm portion 22 of the base plate 14 carries a buffing wheel assembly 66 that includes a buffing wheel 68 that is rotated about a shaft 72 by a motor 74. The buffing wheel 68 is mounted on a housing 78 that can be adjusted up and down relative the arm 22 by a height adjusting mechanism 82. The buffing wheel 68 can be a wire wheel, an abrasive wheel, or a cotton polishing wheel for buffing a welded joint to remove any flash or other impurities and prepare the welded joint for subsequent painting or other metal finishing treatments. The buffing wheel 68 rotates in the direction of arrow 86 so that any offal is pushed away from the laser welder 32.

An arm portion 88 extends from the arm portion 22 and mounts an inspection or vision device 92, which is preferably a camera that gathers images of the welded joint for use in monitoring the quality of the welded workpieces.

Referring to the drawing, it will be understood that the multi-purpose end effector will be moved rightwardly in the direction of arrow 98 along the workpiece joint that is to be welded. Thus it will be appreciated that the various tools are arranged in serial order to sequentially perform the functions of guiding the end effector 10 along the joint, cleaning the workpiece, welding the joint, buffing the joint, and then inspecting the finished joint. Accordingly as seen in the drawing, the guidance camera 62 is followed by the cleaning wheel mechanism 42, which is then followed by the laser welder 32, which is then followed by the buffing wheel assembly 66, and then finally the inspection camera 92 brings up the rear as the end effector 10 moves in the direction of arrow 98.

As seen in the drawing, the cleaning wheel 44 is mounted a sufficient distance from the laser welder 32 so that any foreign matter dislodged by the cleaning wheel 44 will not be thrown into the weld beam 34. The buffing wheel assembly 66 is preferably located on the opposite side of the welder 32 from the cleaning wheel 44 and preferably at a distance from the welder 32 that is reasonably well balanced in terms of weight of the device. By balancing the weight of the various tools around the central base plate 18, the robot is better able to precisely manipulate the end effector 10.

The foregoing description of the invention is merely exemplary in nature and, thus, variations thereof are intended to be within the scope of the invention.

What is claimed is:

1. A multi-purpose end effector for a robot comprising:
a base plate mounted on the robot;
a welder carried by the base plate for welding a joint between the adjoining surfaces of two adjacent workpieces as the robot moves the welder along the joint;
a cleaning wheel carried by the base plate on one side of the welder so that the cleaning wheel precedes the welder as the robot moves the welder along the joint so as to clean the adjoining surfaces in preparation for the welder;
and a buffing wheel carried by the base plate on the other side of the welder from the cleaning wheel so the buffing wheel follows behind the welder as the robot moves the welder along the joint so as to buff the welded joint after welding.

2. The end effector of claim 1 further comprising a vision device carried by the base plate adjacent to the cleaning wheel to move in advance of the cleaning wheel and provide data to the robot by which the robot may guide the cleaning wheel and welder and buffing wheel along the joint.

3. The end effector of claim 1 further comprising a vision device carried by the base plate adjacent to the buffing wheel to move behind the buffing wheel and provide quality inspection data.

4. The end effector of claim 1 further comprising a first vision device carried by the base plate adjacent to the cleaning wheel to move in advance of the cleaning wheel and provide data to the robot by which the robot may guide the cleaning wheel and welder and buffing wheel along the joint and a second vision device carried by the base plate adjacent to the buffing wheel to move behind the buffing wheel and provide quality inspection data.

5. The end effector of claim 1 further comprising said cleaning wheel being mounted on the base plate by a height adjusting mechanism.

6. The end effector of claim 1 further comprising said buffing wheel being mounted on the base plate by a height adjusting mechanism.

7. The end effector of claim 1 further comprising said cleaning wheel and said buffing wheel each being mounted on the base plates by height adjusting mechanisms to enable separate up-down adjusting movements of the cleaning wheel and the buffing wheel relative to the welder.

8. A multi-purpose end effector comprising:
a base plate mountable on a robot and carrying a plurality of tools including a welder, a cleaning wheel for cleaning a workpiece, a buffing wheel for buffing a weld, a guidance camera and an inspection camera, said tools being arranged in serial order on the base plate beginning with the guidance camera to guide the multi-axis manipulator, then the cleaning wheel to clean the work piece, then the welder for welding the workpiece, then the buffing wheel to buff the weld, and then the inspection camera to inspect the buffed weld.

9. The multi-purpose end effector of claim 8 further comprising the welder being a laser welder and having a dispenser for shielding gas and a dispenser for welding wire.

10. The multi-purpose end effector of claim 11 further comprising the base plate having a central base portion and arms extending out in opposite direction from the central base portion.

11. The multi-purpose end effector of claim 8 further comprising welder being mounted on the central base portion and the cleaning wheel and the buffing wheel being mounted on the arms on opposite sides of the central base plate.

12. The multi-purpose end effector of claim 8 further comprising the cleaning wheel and the buffing wheel being located at approximately the same distance from the central base plate.

13. The end effector of claim 8 further comprising said cleaning wheel being mounted on the base plate by a height adjusting mechanism.

14. The end effector of claim 8 further comprising said buffing wheel being mounted on the base plate by a height adjusting mechanism.

15. The end effector of claim 8 further comprising said cleaning wheel and said buffing wheel each being mounted on the base plates by height adjusting mechanisms to enable separate up-down adjusting movements of the cleaning wheel and the buffing wheel relative to the welder.

16. The end effector of claim 8 further comprising said cleaning wheel and said buffing wheel each rotating in a direction away from the welder so that any offal is pushed away from the welder.
